(19) United States
(12) Patent Application Publication
(10) Pub. No.: US 2012/0204829 A1
(43) Pub. Date: Aug. 16, 2012

(54) Rotary engine

(76) Inventor: Reza Fatemi, Lake Balboa, CA (US)

(21) Appl. No.: 12/931,768

(22) Filed: Feb. 10, 2011

(51) Int. Cl. F02B 53/00

(52) U.S. Cl. 123/245

(57) ABSTRACT

A rotary engine comprises a substantially circular hollow chamber including an outer wall portion and an inner wall portion. A piston moves through the chamber in response to combustion of a fuel and air mixture in the chamber, the piston being connected to a piston rod which drives a shaft outside the chamber. A gate is formed in the chamber to provide a transverse seal therein, the gate and piston being configured so that the piston or gate are movable relative to each other between a first position in which the chamber is sealed by the gate and a second position in which the piston avoids the gate as it moves through the chamber. The inner wall of the chamber comprises a fixed wall portion which does not move relative to the piston and a traveling wall portion which moves with the piston, the fixed wall portion and traveling wall portion of the inner wall forming a substantial seal therebetween.

### FIELD AND BACKGROUND OF THE INVENTION

This invention relates to rotary engines. More particularly, the invention is for a rotary engine used to drive vehicles or other devices. The rotary engine in accordance with the invention utilizes a piston which moves in a continuous circular pathway in a ring-shaped chamber, and is attached to a drive shaft which is used to drive a vehicle or other machine, as desired.

A conventional internal combustion (IC) engine which is used on the vast majority of vehicles today comprises an engine block with a plurality of chambers formed in the engine block. Each chamber has associated therewith a piston mounted on a piston rod. The piston reciprocates in the chamber, moving in one direction in response to the firing of an air and fuel mixture, and then returning to its start position by moving in the opposing. direction. This reciprocation of the piston in the chamber repeats rapidly and causes the piston rod to turn a crank or drive shaft, which in turn drives wheels on the vehicle or other devices to cause locomotion thereof.

There are several very early steam engines that have utilized mechanisms and ideas which are roughly based on the configuration of a rotary engine. However, one key problem which manifests itself and that none of these engines appears to solve is how to create an effective seal between the rotor, the casing, and the piston. This is an important element of any internal combustion engine or steam engine since the absence of an effective seal between these components may result in the leakage of gases from the engine which can severely compromise the power output of the engine. This potential leakage constitutes a significant problem to be considered in the design of a rotary engine and the present invention addresses this matter and comprises design and structure which are aimed at keeping the ignited and expanding gases of combustion from leaking out of the chamber in which they are produced.

Additionally, the present invention comprises the presence of mechanisms and structural configurations which are designed to assure that the moving parts of the engine do not bang or knock with each other. In some of the older designs of the engines which utilize some form of rotary piston motion, it would appear that at least some of the metal pieces do collide with each other and may bang together upon opening and closing and other movement of the component parts.

The Bramah & Dickenson engine, the Cartwright Engine, the Chapman Engine, and the Eve Engine are some of the old engines which employ rotary motion.

However, one of the most famous of the rotary engines is the so-called Wankel engine, different in most respects from the present invention. The rotor in the Wankel engine is triangular shaped and travels inside of its casing in an elliptical fashion. A plurality of combustion chambers are formed by the tips of the triangular rotor rubbing on the inside of the casing. This is one of the disadvantages of the Wankel engine, since the contact and resulting friction which is produced thereby will inevitably wear down the rotor tips and this in turn will cause undesirable leakage. Any leakage, of course, compromises power since energy of combustion will be lost for use in driving the rotor, rod and shaft. Additionally, because the rotor in the Wankel engine does not travel in a perfectly circular pathway, many of the advantages that are theoretically possible and follow from the construction of a rotary engine may not be attained by this engine configuration and design.

There is also a design of a rotary type engine called the “Radmax”, but this engine has a design which comprises many small rotors all of which may fit tightly against a series of internal cams which together have an undulating path or motion. This complex path, as well as the fact that the rotors themselves must seal against a compound shape, makes the design overly complex and compromises the ability of the engine to work reliably or efficiently. Additionally, the structure of this engine is such that it has no capacity or ability to “free spool”, as is the case with the present invention, a description and details of which are more fully disclosed below.

### SUMMARY OF THE INVENTION

According to one aspect of the invention, there is provided a rotary engine comprising: a substantially circular hollow chamber including an outer wall portion and an inner wall portion; a piston which moves through the chamber in response to combustion of a fuel and air mixture in the chamber, the piston being connected to a piston rod which drives a shaft outside the chamber; a gate formed in the chamber providing a transverse seal therein, the gate and piston being configured so that the piston or gate are movable relative to each other between a first position in which the chamber is sealed by the gate and a second position in which the piston avoids the gate as it moves through the chamber; and the inner wall of the chamber comprising a fixed wall portion which does not move relative to the piston and a traveling wall portion which moves with the piston, the fixed wall portion and traveling wall portion of the inner wall forming a substantial seal therebetween.

Preferably, the gate is movable between a closed position in which it seals the chamber and an open position wherein the chamber is unsealed and the piston can move freely past the gate, the gate moving to the open position when the piston is moving in close proximity toward the gate in the chamber and to the closed position when the piston is moving away from the gate.

Alternately, the gate may be fixed in the chamber and the position of the piston changes as it approaches the gate to move in a path around the gate such that the gate does not obstruct the piston.

In one embodiment, the fixed wall portion may be between the moving piston and the traveling wall portion and the fixed wall portion has a slot therein for receiving the piston rod, the piston rod being connected to the traveling wall portion and passing through the slot of the fixed wall portion to connect to the piston, the slot in the fixed wall portion being sealed by the presence of the traveling wall portion to prevent combustion gases from escaping from the chamber through the slot.

Preferably, the chamber comprises a ring-shaped tubular member in which the piston follows a continuous circular pathway.

In one embodiment, a rotating cam member may be configured to open the gate as the piston approaches the gate. This arrangement may comprise a first roller slot and a second roller slot, the first and second roller slots receiving a roller, the cam member moving the roller between the first and second roller slots so that the gate is closed when the roller is in the first roller slot and open when the roller is in the second roller slot. The gate may be moved rapidly between open and closed positions in synchronization with the piston so that the two never touch, and when the roller is held by means in the second cam slot the gate is held open so the piston and rotor can “free spool”.

In another embodiment, the piston rod may comprise a retracting portion with the piston retracting out of the way of the gate which is fixed in the chamber.

In another situation the gate “opens” apart for a rotating piston to slip through. The gate does not “leave” the chamber. According to another aspect of the invention, there is provided a rotary engine comprising: a substantially circular hollow chamber including an upper fixed plate and a lower moving plate which cooperate to form the chamber; a piston connected to the moving plate and which moves through the circular chamber in response to combustion of a fuel and air mixture in the chamber, the moving plate driving a crankshaft; and a gate formed in the chamber for providing a transverse seal therein, the gate and piston being configured so that the gate is movable relative to the piston between a first position in which the chamber is sealed by the gate and a second position in which the gate is reoriented so that the piston avoids the gate as it moves through the chamber.

Preferably, the rotary engine comprises drive mechanisms for opening and closing the gate; sensors for sensing the position of the gate and piston; and a processor for operating the drive mechanisms to selectively open and close the gate in response to the sensed position of the piston. The processor may selectively adjust and vary the timing of intake valves and ignition of fuel-air combustion according to need requirements and optimization of engine operation.

According to yet a further aspect of the invention, there is provided a method of operating a rotary engine comprising the following steps: forming a substantially circular hollow chamber including an outer wall portion and an inner wall portion; moving a piston through the chamber in response to combustion of a fuel and air mixture in the chamber, the piston being connected to a piston rod which drives a shaft outside the chamber; locating a gate in the chamber to provide a transverse seal therein, the gate and piston being operated so that the piston or gate are movable relative to each other between a first position in which the chamber is sealed by the gate and a second position in which the piston avoids the gate as it moves through the chamber; and forming the inner wall of the chamber of a fixed wall portion which does not move relative to the piston and a traveling wall portion which moves with the piston, the fixed wall portion and traveling wall portion of the inner wall forming a substantial seal therebetween.

The invention thus, in all variations, may provide a rotary engine wherein a piston moves through a substantially circular chamber, in one direction. The piston forms a seal with the walls of the chamber and is driven through the chamber by the combustion of a fuel and air mixture. Combustion occurs between the piston itself and a gate or wall in the chamber. The rotary engine is configured such that the gate or wall does not provide any obstacle or barrier to the moving piston, at least at the critical point at which their paths cross, and this is accomplished in accordance with the invention by either moving the gate from the path of the piston at the appropriate time of the cycle, or altering the orientation or movement of the piston to avoid the gate. Thus the gate or wall may be fixed in one aspect of the invention, or movable in another aspect of the invention, according to the embodiment of the invention which constitutes the rotary engine.

The piston itself is connected to a piston arm or rod at one end thereof, and the piston arm is connected to a crankshaft or shaft at the other end thereof. The circular motion of the piston in the circular chamber thus drives the shaft which will, in conventional and well known fashion, drive the wheels of the vehicle or otherwise drive the engine to which it is attached, or otherwise perform work intended.

Multiple pistons moving in a circular chamber may be used to provide additional power, as may be necessary in the specific circumstances, to provide the amount of power needed.

In accordance with one aspect of the invention, the chamber has an inner and outer wall. The inner wall preferably comprises a fixed wall portion and a traveling or moving wall portion. The moving wall portion rotates with the piston as it circles through the chamber. The fixed wall portion and moving wall portion of the inner wall are constructed so that they are effectively sealed relative to each other to ensure that the combustion gases in the chamber drive the piston and do not leak out of the chamber, thereby dissipating energy which should otherwise be used to drive the piston. This of course increases the efficiency of the system.

In one aspect, therefore, the invention is for a rotary engine in its numerous variants for use in an internal combustion engine where the piston revolves in a hollow tubular and circular cylinder or chamber and that completes a circular course within the cylinder, and has a gate which opens as the piston moves toward it to allow the piston to pass. Once the piston passes the location of the gate, the gate then closes behind the piston to create a closed combustion space. A fuel and air mixture is introduced into the combustion space and ignited. The combustion produced thereby drives the piston in the cylinder to make a complete circle. This process repeats, with the combusted fuels driving the piston, preferably at least once every rotation thereof, within the cylinder.

In an alternate embodiment of the invention, a different structural configuration is provided wherein the gate is in fact fixed in position within the chamber or cylinder, and the piston retracts or folds to pass either through or under or around the gate.

The movement of the piston in accordance with the invention differs from conventional internal combustion engines in which a piston travels in a reciprocating fashion up and down the course of an enclosed cylinder space. There is an inherent weakness or inefficiency in this design because the piston is propelled by the explosive power of fuel being ignited, only to be forced to reverse direction back within the cylinder once it has traveled to the maximum course allowed by the length of the cylinder space.

In the present invention, by contrast, the structure is such that the piston can keep moving in one direction only, which is preferably circular, and the explosive force of the fuel and air mixture would always be pushing the piston in one direction only. In this way, the piston will gather and build energy through a fluid single direction motion, rather than dissipate or use up energy every time it has to reverse course back into a closed cylinder, expending energy as it compresses the fuel and air mixture. This happens continuously, once every reciprocating cycle, using considerable energy.

In one embodiment of the invention, a piston travels on the inside of an enclosed chamber and as it moves toward a gate formed in the chamber, the gate opens to allow the piston to pass by. Once the piston has passed the gate, the gate closes again behind the piston, forming an enclosed combustion chamber between the gate and the piston. A fuel and air mixture is ignited in this combustion chamber, causing the piston to be pushed through the cylinder. As the piston comes full circle and approaches the gate again, the gate moves out of the way and the process is repeated. An important feature of this embodiment is the presence of a traveling wall that moves with the piston, and has the effect of blocking the expanding gases of combustion from escaping through any gap that may otherwise exist where, for example, the armature of the piston travels.

In a variation of the above embodiment, the armature could instead be a plate that the piston would be mounted on. This arrangement may simplify the construction of the engine and require less refined machining, but the basic idea would be the same, and the requirement for the wall traveling with the piston would remain the same.

In one aspect, the gate may be opened and closed by either a mechanical process of gears, or cams, or another suitable manner. Alternately, the gate may be opened or closed in response to the position of the piston by an electrically driven method.

In any event, a mechanism to hold the gate and valves open for the purpose of “free spooling” may form a part of this invention and may be a component of the construction thereof. For example, there may be a cam design for opening and closing the gate. It should be noted that in all of the embodiments of the rotary engine of the invention described and illustrated herein, the same cam system, or variations thereof, can be used.

It should also be noted that in all embodiments of the invention, the location of the piston and the gate can be moved to suit design and power requirements needs, as well as the specifics of the engine itself. As such, none of the designs or embodiments should be seen as fixed or of inflexible construction in this regard, and all possible combinations of positions should be considered within the scope of this invention.

In one embodiment of the invention, a variation of the arrangements described above comprises the situation where the gate retracts to a location inside of the engine space, toward the drive shaft, instead of to a location outside the engine space, as mentioned above. This embodiment may have the benefit of providing a more compact design over all, since the engine and gates will occupy less space.

In the embodiment described in which a cam structure is used for moving the gate in and out of the way, this design can be used for all the engine variations. It has the advantages in that it may (a) insure that the gate can move out of the way fast enough, and (b) be a simple way to hold the gate open for “free spooling” the engine while operating in an idling mode. All that is needed is a mechanism to nudge the gate into either cam track and this can be easily done by any number of mechanisms and electronic controls, all of which are within the scope of this invention.

In a further embodiment of the invention, the piston may retract or fold out of the way of, or rotate the gate, as opposed to having the gate moving out of the way of the piston. In such an embodiment, the piston would essentially “duck” or move under, or over, a fixed gate in the cylinder. This can be achieved either by folding the piston on a hinge, rotating it on a hinge, or having it retract into a housing. Further, either of these options may be more compact than other designs of the invention, or it may simply be another pathway to achieve the same outcome.

In a further embodiment, the piston may rotate to change its orientation as it moves through the cylinder or chamber in order to present a smaller profile so that the gate could be made smaller and be contained inside the chamber space. This, too, may be a more compact design and the operation of the smaller gate movement to allow through the re-oriented piston may be faster thereby allowing the engine to run faster.

### BRIEF DESCRIPTION OF THE DRAWINGS

In the drawings:

FIG. 1 is a schematic view of a rotary engine in accordance with one aspect of the invention, showing a ring-shaped chamber and rotating piston;

FIG. 2(a) is a cross-section through a rotary engine in accordance with another aspect of the invention, showing a piston moving through a ring-shaped chamber and a gate which opens and closes in the chamber to permit the passage of the piston;

FIG. 2(b) shows a detail of the construction of the fixed wall and the traveling wall of the rotary engine of the invention;

FIG. 2(c) shows a cross section of the construction illustrated in FIG. 2(b);

FIG. 2(d) shows another shape for the traveling wall with additional appendages to help seal with the fixed wall;

FIG. 3 is a top schematic view of a rotary engine in accordance with another aspect of the invention;

FIG. 4 is a schematic cross-sectional view through a rotary engine of the invention, similar to the embodiment in FIG. 3, wherein the gate retracts towards the inside of the engine space to allow passage of the piston;

FIGS. 5(a) and 5(b) show schematic views of further embodiments of the invention showing a moving gate which is able to retract to the interior of the engine;

FIGS. 6(a), 6(b) and 6(c) show various views of a rotary engine in accordance with a further embodiment of the invention which utilize a cam design in the rotary engine for opening and closing the gate to allow passage of the piston as it passes the gate;

FIGS. 7(a) and 7(b) show a schematic view of a rotary engine in accordance with a further embodiment of the invention wherein the gate within the rotary engine is fixed and the piston retracts from the chamber at that point where it passes the gate;

FIG. 8 is a schematic view of a further embodiment of the invention showing a piston which is hinged and pivotally rotates about the hinge to relocate it as it passes the gate in the chamber;

FIGS. 9(a) and 9(b) are schematic views of a further embodiment of the invention showing a rotating piston passing through a reduced-size aperture in the gate, and rotatable between two orientations, the first sealing within the chamber, and the second in which a low profile is presented to the gate to pass through a close able opening therein;

FIG. 10 is a schematic view of a rotary engine in accordance with a further embodiment of the invention showing a larger diameter or cross-section combustion chamber and a reduced diameter or cross-section piston-rotating chamber;

FIG. 11 is a schematic view of a rotary engine in accordance with yet a further aspect of the invention, showing an arrangement with multiple pistons all rotating within a single chamber;

FIGS. 12, 13 and 14 show various views of one configuration of a rotary engine in accordance with an aspect of the present invention;

FIGS. 15 to 18 show designs for hinged gates and/or pistons of different shape and configuration which may be used in accordance with different aspects of the invention;

FIGS. 19 and 20 show yet a further embodiment in accordance with the present invention with a hinged gate mechanism illustrated in the open and closed positions respectively;

FIGS. 21 and 22 show yet a further embodiment in accordance with the present invention with a hinged piston mechanism illustrated in the closed and open positions respectively;

FIGS. 23 and 24 shows still a further embodiment in accordance with the present invention with a hinged gate mechanism illustrated in the closed and open positions respectively; and

FIGS. 25 to 28 show a further configuration illustrating the interaction between a gate and piston member whereby a piston is able to travel past the position of the gate in the rotational cycle.

### DETAILED DESCRIPTION OF THE INVENTION

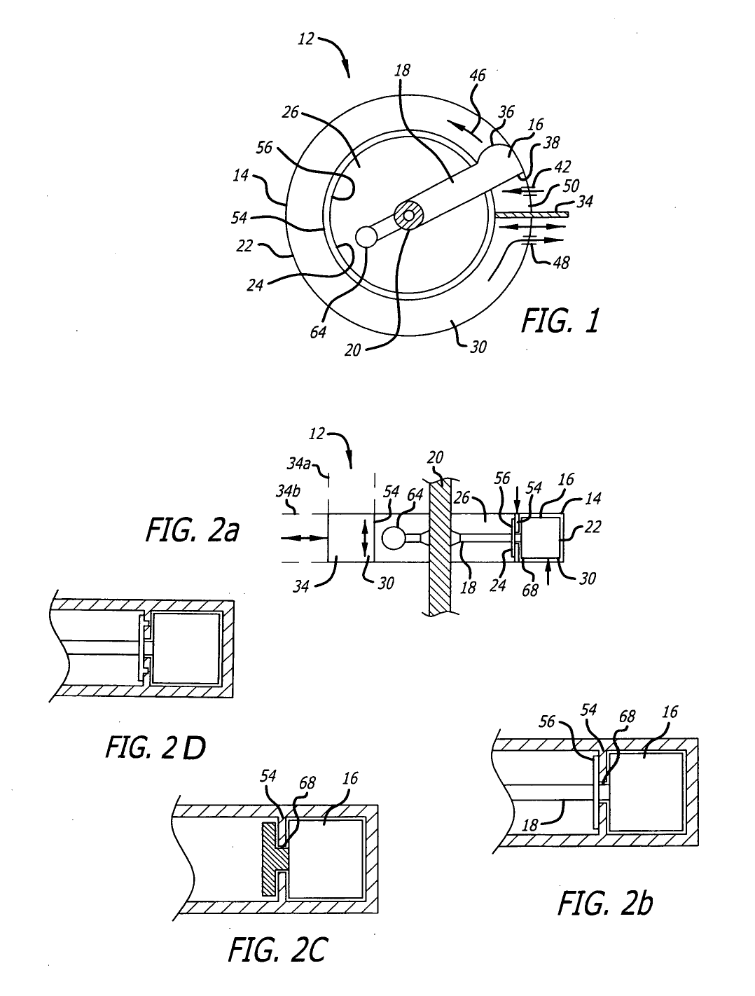

Reference is now made to FIG. 1 of the drawings which shows one of several embodiments of a rotary engine which may be constructed and configured in accordance with the present invention. Generally, the rotary engine, in accordance with the invention, comprises an annular or ring-like chamber through which a piston travels. The piston travels continuously in one direction so that no reciprocating movement thereof is required, as is the case in a conventional internal combustion engine. The piston itself is connected by means of a piston arm to a crankshaft, and rotates the crankshaft as it moves through the chamber.

Common to the rotary engine configuration of the present invention is the presence of a gate or wall transversely located in or across the chamber. This wall, together with the piston, when in close proximity of the wall, defines a combustion chamber which receives an air-fuel mixture, the air-fuel mixture being ignited to propel the piston along its circular journey through the chamber. In accordance with the invention, it is, of course, necessary for the piston to move continuously through the chamber without obstruction, and to this end, either the gate is retracted or withdrawn at the moment when the piston is about to pass that point in the chamber at which the gate is located, or the piston itself is retracted, reoriented, pivoted or otherwise moved so as to avoid or cooperate with the gate or wall, to facilitate its movement past the wall.

The rotary engine in accordance with one aspect of the invention also comprises a double wall, or two part wall, at least on the inside thereof, a significant feature which allows the piston to be connected to the piston arm, or shaft, in a manner which keeps the chamber effectively sealed during the cycle of the piston therethrough. The inner wall may comprise a fixed component and a moving component, the two being sealed with respect to each other, and together defining a sealed wall whereby the piston can move through the chamber, while being connected to the piston arm, and without dissipating any energy through the wall which may otherwise result when the piston arm is connected to the piston.

FIG. 1 of the drawings shows one of the embodiments of the rotary engine 12 in accordance with one aspect of the invention. The rotary engine 12 comprises an annular cylinder 14, a piston 16 moving through the annular cylinder 14, a piston arm 18 connected to the piston 16 at one end, and a crankshaft 20 connected to the piston arm 18 at its other end, and rotated thereby to drive, for example, a vehicle in a manner conventionally known.

The annular cylinder 14 comprises an outer wall 22 and an inner wall 24. The annular cylinder 14 defines an interior space 26 in which the crankshaft 20 is located and in which the piston arm rotates as driven by the piston 16, in turn rotating the crankshaft 20. The annular cylinder 14 is hollow, defining therein a continuous consistently dimensioned chamber 30.

The annular cylinder 14 has located at one point therein a gate 34 which is movable between a closed position, as shown in FIG. 1 of the drawings, and an open position, whereby the gate 34 is retracted in a radial direction outwardly from the chamber 30, or alternatively upwardly perpendicularly to the piston. When the gate 34 is fully retracted so as to be outside of the chamber 30, a free open passage is provided so that the piston 16 can move through the annular cylinder 14 at that point where the gate 34 would otherwise be located.

It will be appreciated that the opening and closing mechanism of the gate 34, as will be described in further detail below, is effected so that the gate 34 opens immediately before the leading surface 36 of the piston 16 is about to impact the gate 34, and closes in a sealing fashion immediately after the trailing surface 38 of the piston 16 has passed the circumferential point at which the gate 34 is located.

The annular cylinder 14 comprises an inlet 42 through which a mixture of fuel and air is injected, as would be the case in a corresponding reciprocating motion internal combustion engine. The inlet 42 is located a short distance downstream of the gate 34. It will be appreciated that the piston 16 travels in the direction indicated by the arrow 46.

A means of ignition is provided so that the air-fuel mixture injected into the chamber 30 is ignited, providing the necessary explosive force to drive the piston 16 through the chamber 30. Any number of commonly accepted means may be used, such as spark plugs or novel new means such as lasers, etcetera.

The annular cylinder 14 further comprises a discharge outlet 48 by means of which gases and products of combustion may be eliminated from the chamber 30. The discharge outlet 48 is located a short distance upstream of the gate 34, so that the products of combustion will drive the piston 16 through the chamber 30 through most of its course or path through the chamber 30, and allow these products of combustion in front of the piston to escape the chamber 30 as the piston 16 moves through the chamber, forcing the gasses out of the exhaust outlet prior to the gate opening to allow the piston to pass.

Within the chamber 30, a combustion chamber 50 is formed when the gate 34 is in the closed position, and the piston 16 has moved a short distance downstream in the direction of arrow 46, as it courses away from the gate 34. The combustion chamber 50 is defined by the surface of the gate 34, the trailing surface 38 of the piston, the outer wall 22, the inner wall 24, and the traveling wall which fills the slot the piston moves through. The illustration in FIG. 1 of the drawings shows the piston 16 located so as to define the combustion chamber 50. It will be seen that the inlet 42 for the air-fuel mixture discharges into this combustion chamber 50 and the air-fuel mixture is ignited, as already mentioned, when the piston 16 is at the approximate point, as shown in FIG. 1 of the drawings, in each rotation of the piston 16 in the chamber 30. Naturally, any number of commonly used means for injecting air-fuel mixture may be used. As with common designs, if valves are opened to allow fuel-air mixture, these valves are closed just prior to ignition.

It will, of course, be appreciated that the rotary engine 12 as illustrated in FIG. 1 of the drawings, as well as the other embodiments described herein, may be adjusted and varied according to need. For example, the diameter or cross-section of the chamber 30, and the size of the piston 16 can be varied. In addition, the precise position of the piston 16 within the chamber 30 can be varied or adjusted at the point when the air-fuel mixture is ignited. In other words, the size or volume of the combustion chamber 50 can be varied according to need. In addition, the combustion chamber may be smaller at start-up speeds, so as to provide more force for driving the movement of the piston, but increase in volume or size as the as the speed of rotation of the piston 16 increases, where the explosive force of the air-fuel mixture is not necessarily accelerating the piston 16, but rather maintaining its speed. These and other parameters for the optimal functioning of the engine may be controlled by a computer or processor with engine sensors providing feedback and information to be processed for appropriate adjustment and variation of engine operation.

As shown in FIG. 1, the inner wall 24 comprises a fixed cylindrical portion 54 and a traveling cylindrical portion 56. This arrangement can be more fully understood with respect to FIGS. 2(a) and 2(b) of the drawings, which will be described in more detail shortly. In effect, the fixed cylindrical portion 54 is internal, or defines the chamber 30, while the traveling cylindrical portion 56 is formed radially and inwardly of the fixed cylindrical portion 54 and travels in a circular motion with the piston 16 and piston arm 18. The traveling cylindrical portion 56 and fixed cylindrical portion 54 are preferably configured with high tolerances so as to be directly adjacent to each other in a sealing manner, so that the products of combustion will not be able to escape from the chamber 30 through the inner wall 24, thus dissipating the energy produced, and reducing the force on the piston 16 as it is driven through the chamber 30. One possible example of such a construction is illustrated in FIG. 2(d) of the drawings which shows another shape for the traveling wall, with additional appendages to help seal with the fixed wall. There are many different potential configurations and shapes to help seal and interlock the traveling wall and the fixed wall and all variations are covered by the scope of this invention.

Reference is now made to FIG. 2(a) of the drawings which shows a cross-section through a rotary engine of the type generally, but not identically, shown in FIG. 1 of the drawings. To the extent possible, similar reference numerals have been used for continuity and ease of understanding. It will be seen that FIG. 2 shows the rotary engine 12 having an annular cylinder 14, a piston 16, and the piston arm 18 connected to a crankshaft 20. The annular cylinder 14 includes the outer wall 22, as well as an inner wall 24, which itself comprises the fixed cylindrical portion 54 and the traveling cylindrical portion 56. The piston 16 travels in the chamber 30 in a circular motion. In FIG. 2 of the drawings, the piston shown in its present position would be moving away from the viewer, or into the page.

It will be seen that the crankshaft 20 has attached thereto a counterweight 64, an optional feature or component which may facilitate power management of the rotary engine by storing and dispensing energy built up through the momentum of rotation. The presence, size, weight and shape of the counterweight 64 may of course be varied and have many modified forms. It will be seen that the counterweight 64 rotates within the inner space 26 of the annular cylinder 14. Alternatively, a plurality of pistons can be arranged so they effectively counterweight each other.

The gate 34 can be seen in the chamber 30 of the rotary engine, on the side thereof, opposite to which the piston 16 is illustrated. In FIG. 2(a) of the drawings, the phantom lines indicate that the gate may be removed from the path of the oncoming piston 16 in one of two fashions in this embodiment. The gate 34 may be either raised vertically as shown by the phantom lines 34a, or the gate 34 may be moved horizontally, as shown by the phantom line 34b. In either event, the removal of the gate 34 allows free and unobstructed passage of the spinning piston 16.

It will be appreciated that the gate 34 can be moved from its position in the chamber by appropriate motors, spring-loaded mechanisms, solenoids, cam mechanisms, or any other convenient manner. Further, the timing of the removal or retraction of the gate 34 may be triggered by the presence of sensors, which detect the presence of the moving piston 16 at a particular point, and in turn activate the mechanism for opening the gate 34. Correspondingly, sensors may be provided to detect that the piston 16 has passed the location of the gate 34, therefore triggering the immediate closure of the gate 34, after which the necessary fuel-air mixture may be introduced into the combustion chamber 30, ignited, and continue to propel the piston 16 through the chamber 30.

It will also be seen in FIG. 2(a) of the drawings that the fixed cylindrical portion 54 and traveling cylindrical portion 56 are intended to interact with each other with a high degree of tolerance. This ensures an adequate seal to prevent leaking of the products of combustion. In FIG. 2(a), the traveling cylindrical portion 56 is in fact attached to the piston arm 18. The fixed cylindrical portion 54 comprises an annular or ring-like slot 68 (see FIG. 2(b)) just sufficiently large to enable the piston arm 18 to pass from its position where it is attached to the traveling cylindrical portion 56, to connect to the piston 16. The traveling cylindrical wall also has a projection which fills the slot in a ring fashion, providing additional sealing of the ring slot 68.

FIG. 2(b) of the drawings is a detailed illustration showing in schematic view the arrangement between the fixed wall 54 and the traveling wall 56. It will be seen that the fixed wall 54 comprises the slot 68 through which the piston arm 18 passes and connects directly to the piston 16. It will be appreciated that FIG. 2(b) is a schematic representation only, and that in practice the tolerances will be high so that the traveling wall 56 and the fixed wall 58, together with the piston arm 18, create a tight seal to substantially prevent the escape of any of the combustion gases.

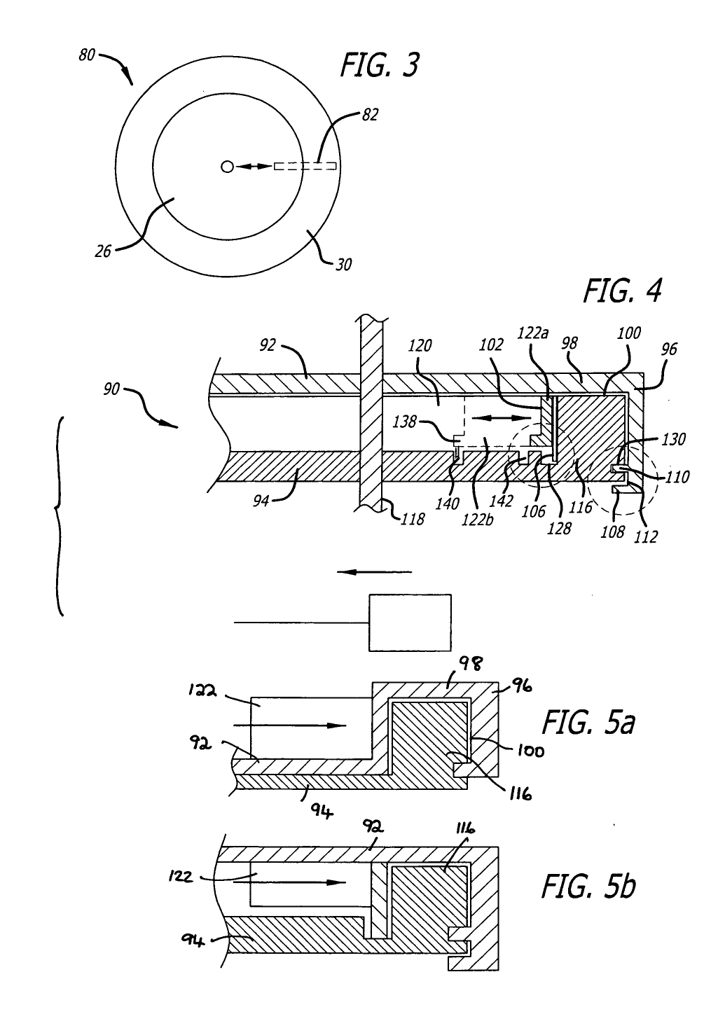

With reference to FIG. 3 of the drawings, there is shown a schematic plan view of a rotary engine 80 in accordance with the present invention, which may have many parts and components similar to those already described and illustrated with respect to FIGS. 1 and 2 of the drawings. In FIG. 3, however, there is shown a gate 82 which retracts from the chamber 30 (again, where appropriate, similar reference numerals have been used for continuity, even though the embodiment may be somewhat different). The gate 82 retracts to the interior space 26, where it is housed while the piston passes the point at which the gate 82 is located. Thereafter, the gate 82 is restored to its position within the chamber 30 and will function much in the same way as has already been described. One advantage of having the gate 82 retract to the interior space 26 is that, the rotary engine 80 may be more compact in design, since space outside of the annular cylinder 14 would not be needed to house the gate 82 which is moving between the retracted and operative positions. Other structures which may be present within the rotary engine 80, will, of course, be modified to operate with the gate retracting into the interior space 26.

With reference to FIG. 4 of the drawings, there is shown as detail cross section of an embodiment of the invention where the gate is retracted to the inside of the rotary engine. In FIG. 4, there is shown a rotary engine 90 including an upper fixed plate 92 and a lower moving plate 94. The upper fixed plate 92 includes an outer side wall 96, and a top wall 98, which define the top and side respectively of a chamber 100. The inside of the chamber 100 is defined by an inner vertical wall 102. The inner vertical wall 102 is attached at its upper end to the top wall 98, and has an extension 106 which helps to seal the chamber 100 in a manner to be described.

The outer wall 96 has at its lower end a lip 108 and a flange 110, the lip 108 and flange 110 defining a channel 112, also for sealing purposes which will be described.

The lower moving plate 94 has positioned thereon a piston 116 which is driven through the chamber 100. As the piston 116 moves through the chamber 100, the moving plate 94 rotates with it. The moving plate 94 attaches to a crankshaft 118 which drives a drive shaft of other component in conventional fashion.

The upper fixed plate 92, the lower moving plate 94 and the inner vertical wall 102 also define an interior space 120. A gate 122 is provided which is able to shift into the chamber 100 and to the interior space 120 in response to movement of the piston 116, as will be described.

The lower moving plate 94 includes a recess 128 which receives the extension 106. The lower moving plate 94 further comprises a recess 130 which is received within the channel 112. The extension 106 in the recess 128, and the recess 130 around the flange 110 and adjacent the lip 108 causes an effective seal between the upper fixed plate 92, lower moving plate 94 and inner vertical wall 102 respectively, so that the chamber 100 is effectively substantially sealed to prevent leakage of any combustion gases therefrom. These extensions and recesses effectively perform the same function of the traveling wall in the earlier embodiment of the invention above.

As described above, the gate 122 is movable between a position in which it is in the chamber 100, as shown by reference numeral 122a. The gate 122 can move into the interior space 120, as shown by the gate 122 illustrated in phantom lines, and having reference numeral 122b. The gate 122 includes a projection 138.

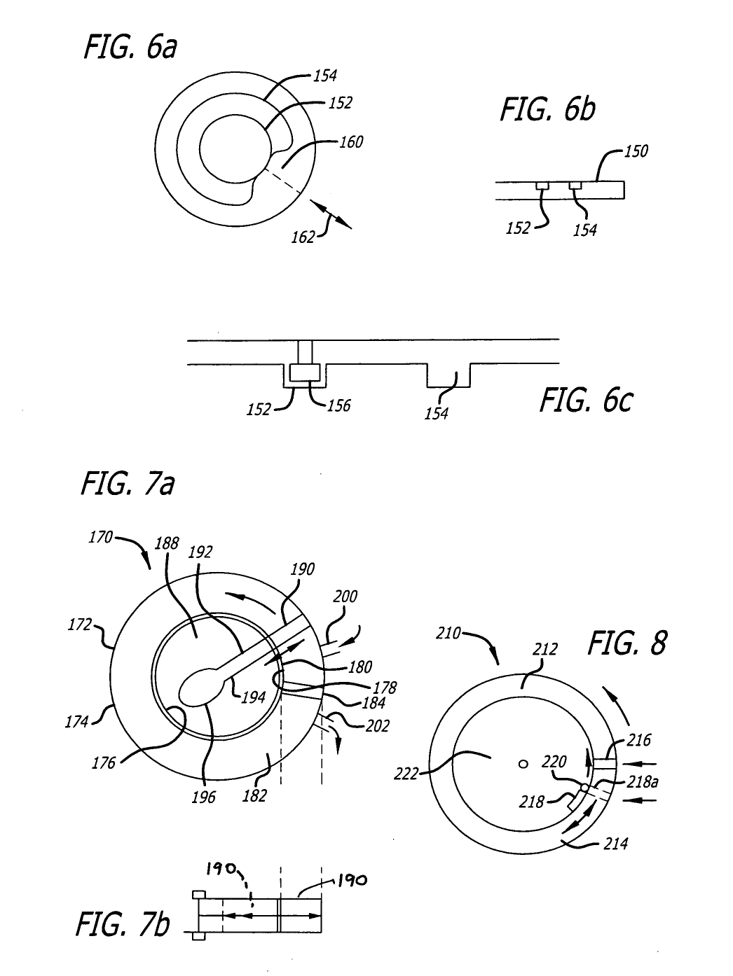

The moving plate 94 has a pair of cam slots 140 and 142 which cooperate with the projection 138 on the gate, to allow the gate 122 to open when the piston 116 is moving towards it and is about to reach it, and then close the gate 122 once the piston 116 has moved past this position. There are two paths for the cam slots, one which opens and closes the gate (see FIG. 6(a)) slot number 154 and one which holds the gate open 152. When the gate is held open it allows free spooling of the engine.

FIG. 5(a) of the drawings shows another embodiment of the invention where the gate is shown to move in the opposite direction, while FIG. 5(b) of the drawings shows a variation of the embodiment shown in FIG. 4 with upper fixed plate and lower moving plate, as described.

With reference to FIGS. 6(a), 6(b) and 6(c), further details and illustration relating to the cam slots and operation in opening and closing the gate are illustrated. FIG. 6(b) shows a lower moving plate with inner slot 152 and outer slot 154. In FIG. 6(c), it is shown that a roller 156 rides in the inner slot 152. A cam 160 as shown in FIG. 6(a) rotates as the piston rotates. The position of the cam 160 will cause the roller 156 to ride either in the slot 152, or the slot 154. When the roller 156 is riding in slot 152, the gate indicated by reference numeral 162 will be in the open position. However, when the cam 160 causes the roller 156 to move into the slot 154, the gate 162 will be able to move to the closed position. The cam 160, roller 156 and slots 152 and 154 are configured with respect to each other so that the gate 162 will, of course, open as the piston is approaching the gate 162 so that it can pass through the chamber.

It should be noted that this design makes it certain that the gate will always be open for the piston to pass. Additionally, means are provided for the roller to remain in slot 152 when engine free spooling is desired. Examples are during idling, coasting etc.

FIGS. 7(a) and 7(b) show a further embodiment of the invention, one in which the piston itself retracts or folds out of the way of the approaching gate, rather than the opposite situation where the gate moves away to accommodate passage of the piston. In FIGS. 7(a) and 7(b), there is shown a rotary engine 170 having an annular cylinder 172 with an outer wall 174 and an inner wall 176. The inner wall 176 itself has an outer surface 178 and an inner surface 180.

The annular cylinder 172 defines a chamber 182, the chamber 182 including a wall 184 which is fixed, and unable to move. The annular cylinder 172 further defines an interior space 188.

The rotary engine 170 further comprises a piston 190 which rotates within the chamber 182, as described. The piston 190 connects to a piston arm 192, which itself connects to a crankshaft 194, as described. In this particular case, the piston arm 192 has a counter balance 196.

The annular cylinder 172 includes an inlet 200 for the fuel and air mixture, as described, as well as an exhaust 202 through which the products of combustion can be discharged.

The piston 190 comprises a telescoping arrangement with the piston arm 192. In this regard, the piston arm 192 has an internal bore. The piston 190 is movable between a first position in which the piston is outside of the bore of the piston arm 192, and is located in the chamber 182, and a second position wherein the piston 190 is retracted fully into the bore of the piston arm 192 so that it is not in the chamber. This retraction of the piston 190 into the piston arm 192 occurs just before the piston 190 would impact th wall 184, and the piston 190 is once again moved into the extended position just after or downstream of the wall 184. In FIG. 7(a) of the drawings, the piston 190 is shown in its position in its circular cycle a short distance downstream of th wall 184, defining with the wall 184 a chamber for combustion of th air and fuel mixture which is introduced through the inlet 200 and ignited in the chamber.

Reference is now made to FIG. 8 of the drawings which shows yet a further embodiment of the invention. In this embodiment, a rotary engine 210 comprises an annular cylinder 212 having a chamber 214, a fixed wall 216 being placed within the chamber 214. A rotating piston 218 is provided, and connected to a hinge 220. The piston 218 is normally biased so as to be in the position shown in phantom lines as 218a, forming a seal in the chamber 214, so as to operate in a manner already described above. However, as the piston 218 approaches the wall 216, it will be caused to rotate about the hinge 220, and pivot into the interior space 222 for the duration of the cycle where the piston is passing the location of the wall 216. Pivoting at the appropriate time in the cycle will be triggered by, for example, a mechanical cam outside the chamber which pivots the piston, or is similar to the description above or other means.

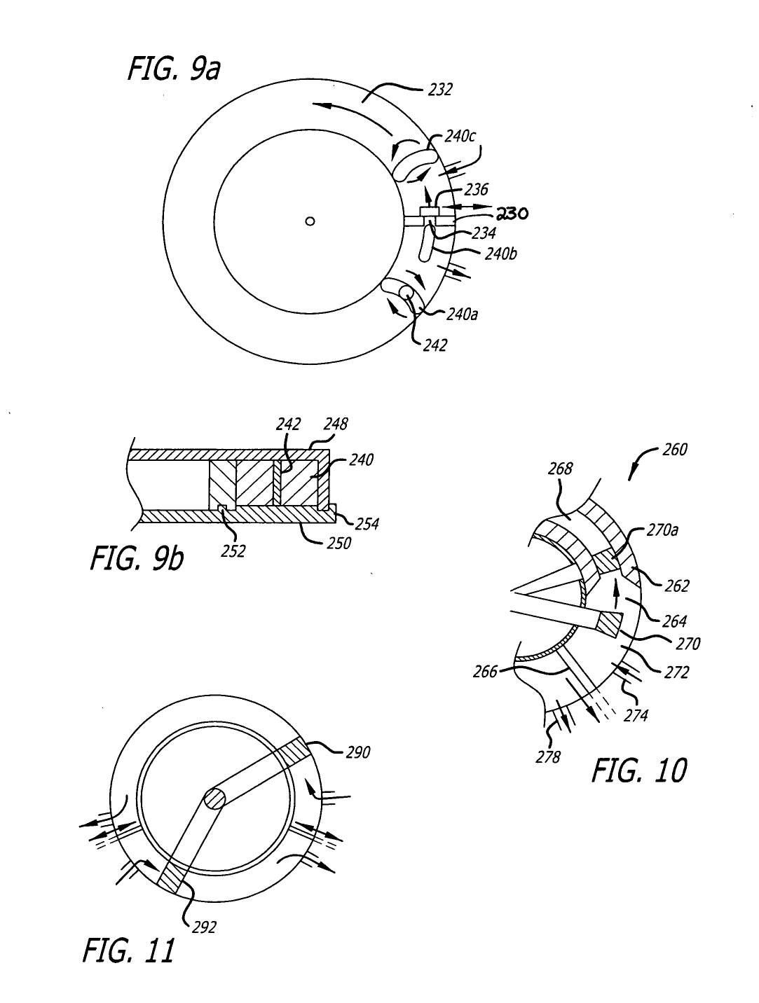

FIGS. 9(a) and 9(b) show a further embodiment of the invention. In this embodiment, a wall 230 is provided in chamber 232, the wall 230 having an opening 234 and a gate 236 which can move with respect to the opening 234. In one position, the gate 236 covers and seals the opening 234, but when the piston 240 approaches the wall 230, the gate 236 moves into the open position so as to allow the piston 240 to pass therethrough.

The piston 240 itself is preferably of a contoured shape, and mounted on a pivot 242. For most of the cycle, the piston 240 is in the orientation shown as 240a, sealing the chamber 232 during the piston cycle. However, when the piston 240 approaches the gate 236, and the gate 236 opens, the piston 240 rotates about the pivot 242 into a position shown by reference numeral 240b. In this condition, the piston 240 presents a thinner profile to the opening 234 in the wall 230 and is able to pass therethrough. As soon as the piston 240 in its smaller profile passes through the opening 234, it is once again restored to its position as shown in 240c, and completes the remainder of its cycle in this position, providing the necessary seal in the chamber 230 to effectively use the products of combustion. Pivoting at the appropriate time in the cycle will be triggered by a mechanical structure which pivots the piston 240, by a motor turning the pivot 242, or such other mechanism, such as a solenoid, spring, gear, cam or process.

It will also be noted, from FIG. 9(b), that the chamber 232 is defined by a fixed housing 248, and a plate 250 that spins with the piston 240. Seals 252 and 254 are provided.

FIG. 10 of the drawings shows yet a further embodiment of the invention. In this embodiment, a rotary engine 260 is comprised of the annular cylinder 262. The annular cylinder 262 has a wider diameter chamber 264 immediately downstream of the gate 266, but the wider chamber 264 tapers to a narrower chamber 268 over most of or a substantial part of the remaining circular portion of the entire chamber 264. A smaller piston 270 is provided which sealingly engages within the narrower portion cylinder 268. A combustion chamber 272 with inlet 274 is provided, and the products of combustion will ignite when the piston 270 has just entered the narrower portion 268 of the cylinder, as shown by reference numeral 270a. In this way, a larger volume combustion chamber is provided, which may provide additional force through the principal of the venturi effect to drive the piston.

In this embodiment, it should be noted that the gate 266 moves to the outside of the chamber, and that an exhaust 278 is provided near the gate 266, slightly upstream thereof, but this configuration can just as easily be reworkable to allow the gate to move internally, as discussed above.

FIG. 11 of the drawings shows yet another embodiment. wherein a plurality of pistons, in this case two pistons 290 and 292, are provided. Each piston 290, 292 has its own piston arm. The pistons in this embodiment are not equally spaced because the design is meant to be used as a pump which moves fluid or gas continuously—unlike most other designs which are intermittent. Otherwise, variations in the structure and operation of the remainder of the rotary engine shown in FIG. 11 of the drawings may be adapted, modified and varied in the manner described in the previous embodiments, and otherwise within the scope of the invention.

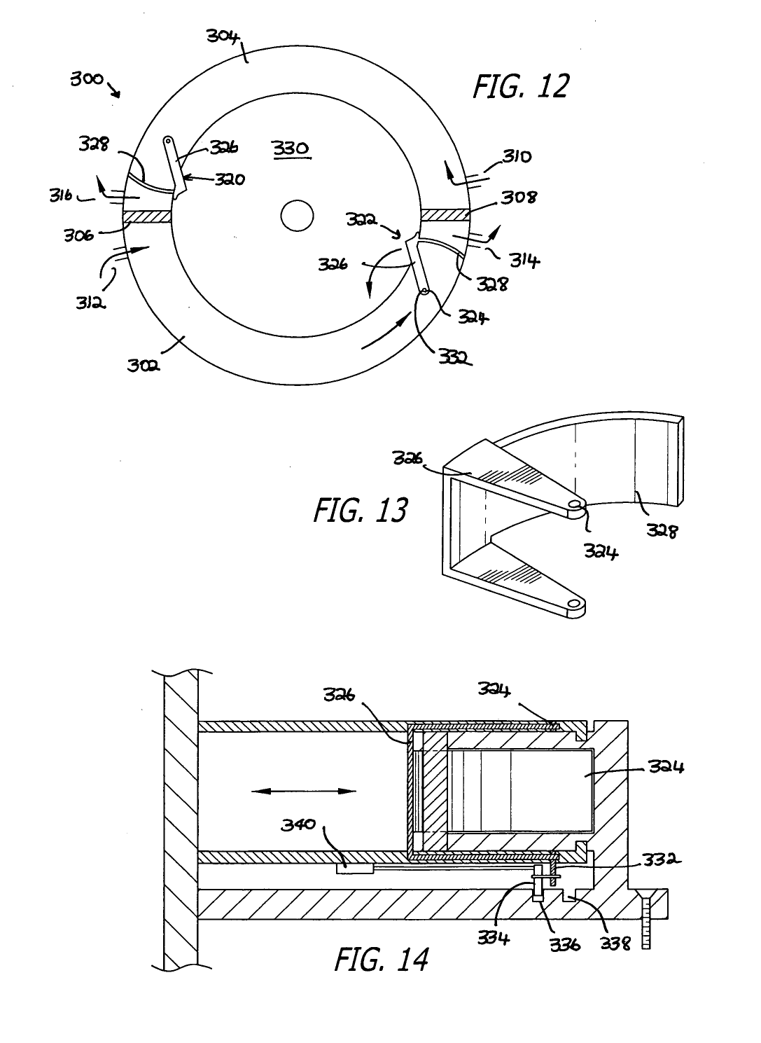

Reference is now made to FIGS. 12 to 14 of the drawings. In these drawings, there is illustrated a rotary engine 300 having a pair of chambers 302 and 304 which are partitioned off from each other by the presence of gates 306 and 308 which are positioned substantially diametrically opposite from each other so that to substantially equal sized chambers 302 and 304 are thereby created. The chamber 304 has a fuel and air inlet 310 and an outlet 316 for combusted gases. Likewise, the chamber 302 has a fuel and air inlet 312 and an outlet 314 for combusted gases.

A pair of pistons 320 and 322 are provided and these are propelled through the chambers 302 and 304 by the force of the combusted air and fuel mixture, as generally described above. Each piston 320 and 322 is comprised of a bracket 326 having a hinge hole 324, and a piston surface 328. The bracket 326 is connected through hinge holes 324, by means of bolts or other suitable hardware, to the rotating engine wall.

As the piston surface 328 approaches either one of the walls 306 or 308, the piston surface 328, which has a curved shape, will be moved out of the chamber 302 or 304. The piston surface 328 is allowed to move outward into the interior space 330 by pivoting about the bolts 332 in at least one of the pivot holes 324. The piston surface 328 will therefore move out of the chambers 302 and 304 at the location of the walls 306 and 308, and will return to the position inside of the chambers 302 and 304 immediately downstream of the walls 306 and 308. This precise movement may be achieved by means of the bolt 332 connecting the bracket 326 to a pin 334 which travels in a recess 336. The recess 336, which may have an appropriate pathway or track, will guide the pistons 322 and 324 in a circular pathway, and moving the piston surface away from the wall by appropriate pivoting of the bracket around the wall. Additionally, the pin 334 has a second track 338 which a nudging device 340 can push and hold the pin 334 in which allows the pistons to hold in their position out of the chamber thus effecting free spooling as mentioned in other variations of the engine.

Further, there may be additional configurations possible with this type of curved piston design whereby the piston can be used as a gate instead and the fixed wall 308 can be made into a traveling piston rather than a fixed wall. The piston/gate can be mounted to either retract into the engine as noted in FIGS. 12 and 14 or it can also be configured to exit the chamber radially outside of the chamber or vertically up out of the chamber, and all these variations are within the scope of this invention.

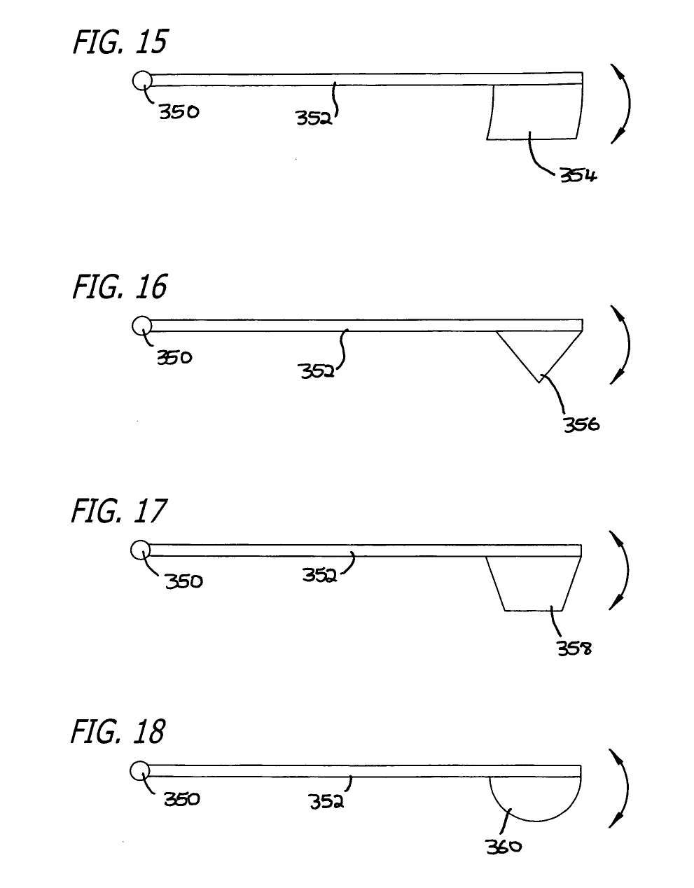

FIGS. 15 to 18 show various embodiments and representations of a hinged gate or piston. The hinged gate or piston comprises a hinge area 350, an arm 352 and a gate 354. In FIG. 15, the gate 354 is more or less rectangular with slightly arced sides. In FIG. 16, the gate 356 is more or less triangular, and in FIG. 17, the gate 358 is more or less trapezoid in shape. In FIG. 18, the gate 360 is of a semicircular shape.

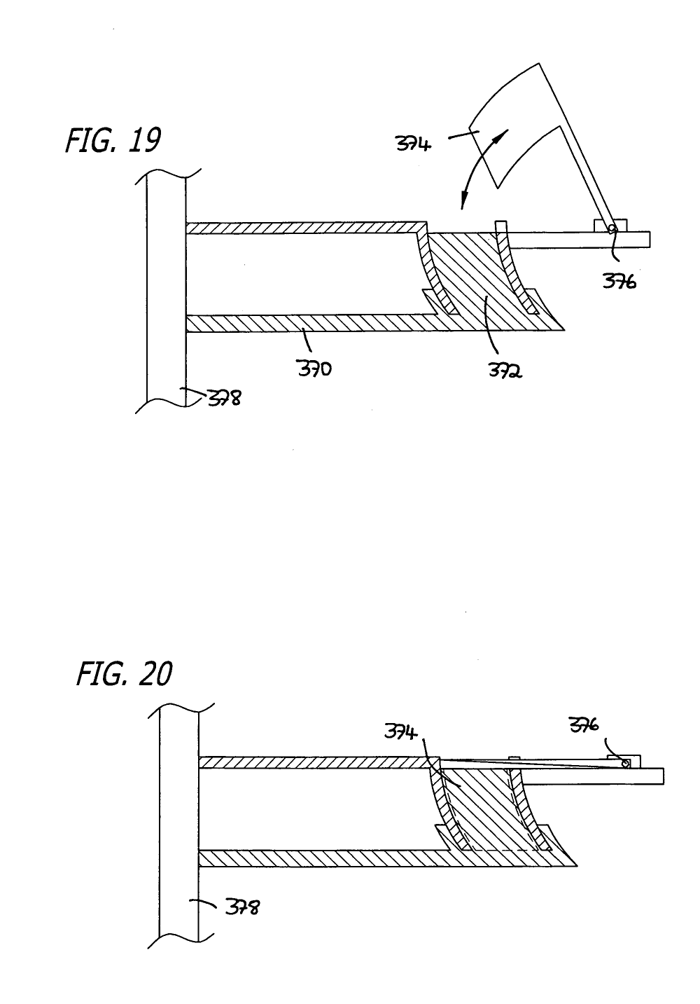

With reference to FIGS. 19 and 20 of the drawings, there is shown a portion of a rotary engine 370 including a piston 372. A hinged gate 374 is shown in FIG. 19 in the open position, and rotates about pivot 376 to move into the closed position, as shown in FIG. 20 of the drawings. When in the closed position, the gate 374 provides a transverse wall within the chamber to allow combustion of the air and fuel mixture to facilitate propulsion of the piston 372 in the chamber in a circular direction, as described above. The piston 372 drives a crankshaft 378.

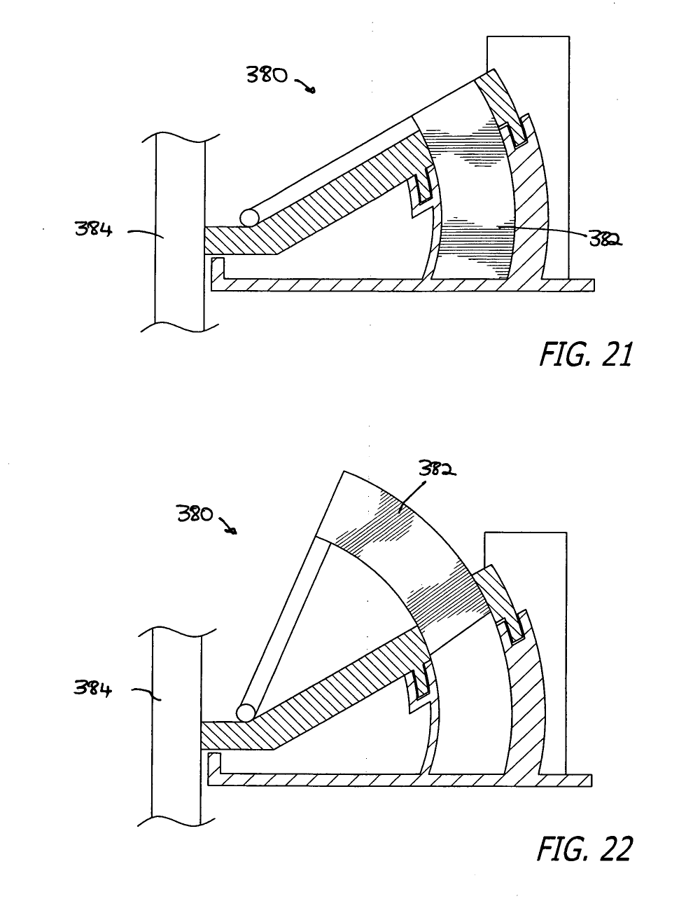

In FIGS. 21 and 22 of the drawings, an alternative embodiment of a rotary engine 318 is illustrated, including a hinged piston 382 movable between a closed position as shown in FIG. 21 where the gate 382 provides a transverse wall within the chamber, and an open position as shown in FIG. 22 which allows the piston to pass in the location where the wall would otherwise be located. It will be seen that in these FIGS. 21 and 22, the chamber is somewhat arcuate in shape, and drives a crankshaft 384.

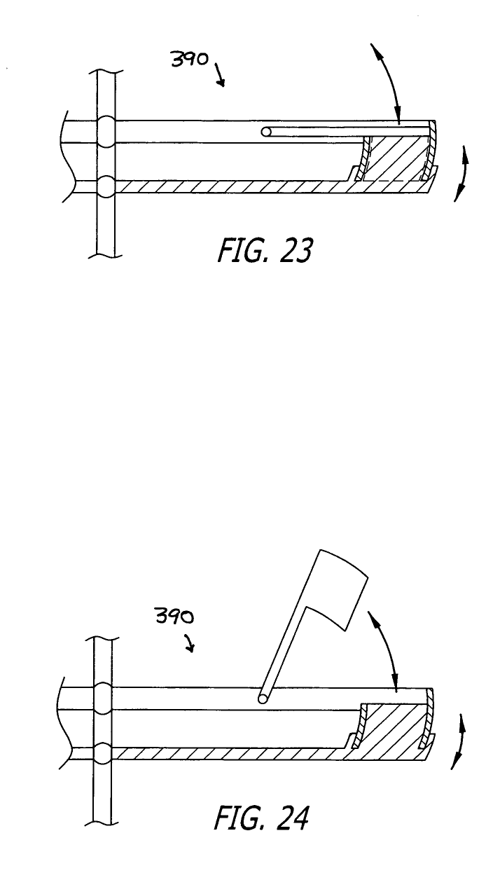

In FIGS. 23 and 24 of the drawings, there is shown yet a further configuration of a rotary engine 390, with a gate which pivots in and out of the chamber, FIG. 23 of the drawings showing the gate in the closed position within the chamber, and FIG. 24 showing the gate in the open position to allow passage of the piston.

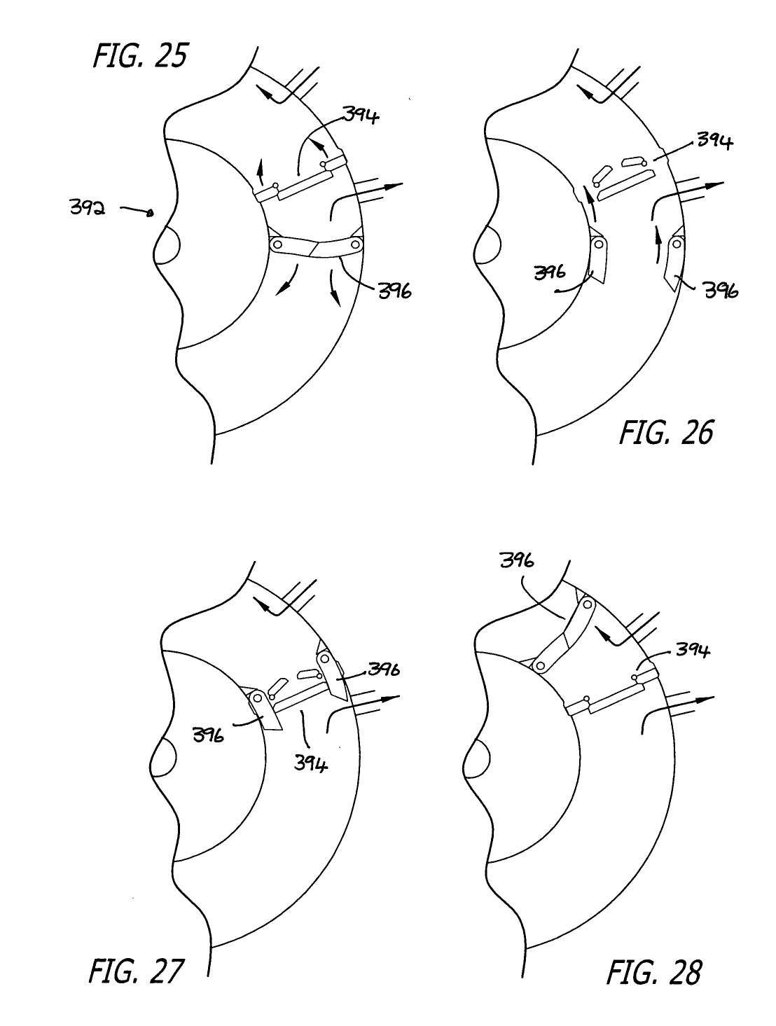

FIGS. 25 to 28 shows another embodiment of a rotary engine 392 illustrating sequentially the movement of the gate 394 and piston 396 in accordance with the present invention. It will be seen that the gate 394 comprises a central portion and two pivoting lateral portions. The piston 396 comprises a pair of engaging lateral portions which also pivot. FIG. 25 shows the gate 394 and piston 396 in the normal operating position. As the piston 396 approaches the gate 394, the lateral portions of the piston 396 separate by folding back towards the wall of the chamber, while the lateral portions of the gate 394 pivot around towards the interior of the chamber to provide small passages on each side through which each of the lateral portions of the piston 396 are respectively allowed passage. FIG. 27 shows the separated lateral portions of the gate 394 passing through this space, while FIG. 28 shows the piston 396 and the gate 394 returned to their normal operating positions. Note that an inlet for fuel and air mixture is suitably located so that combustion takes place when the piston 396 is appropriately distanced from the gate 394.

It will be appreciated that the rotary engine of the invention can take a number of different forms, shapes and modifications. In all of these forms, a piston travels through a tubular, annular ring in a continuous rotational fashion, and a transverse seal is provided in the chamber. This transverse seal, which may be in the form of a wall, is either movable itself, or the piston can move or have its position modified to avoid impact with the wall. Furthermore, the rotary engine in accordance with the present invention addresses the issue of adequate seal by providing the fixed wall and traveling wall, in its various embodiments and modifications for enhanced effectiveness. Additionally, all variations of the invention may incorporate the unique ability to “free spool”.

### Other Features and Characteristics of the Invention

The rotary engine of the invention as described herein offers a number of advantages and benefits, several of which are now discussed. At the outset, it should be noted that the piston never reverses course, moving in one direction only so that it can build energy as it does so. The operation is somewhat analogous to hitting a tether ball around a pole. As it moves around the pole, the ball keeps building energy and momentum as it is hit. Therefore, the rotary engine of the invention comprises structure and operation that allow it to have greater fuel efficiency.

In one example, the valves and gate can be left open, or in the case of the retracting piston, the piston can be left retracted. Thus if the engine is idling the fuel can be shut off and because there is nothing to prevent the piston from turning, it can be left in a “free spooling” mode until the engine is once again needed to perform work. In this way, a car stopped at a red light will not be pumping fuel into the engine and the fuel can be turned off while still allowing the engine to keep spinning. A car in stop and go traffic may perform similarly. This can greatly increase efficiency since the engine does not need fuel to remain in idle and can sit in the “free spool” mode for extended periods until the driver presses the gas when the light turns green or traffic starts to move again. Such an engine may also be teamed with a hybrid design vehicle, once again enhancing efficiency significantly.

The “combustion chamber” in a conventional reciprocating engine is of a fixed volume because the available space is finite. In the present invention, the combustion chamber is variable in volume and can be adjusted subtly in accordance with the situational variables that may be encountered during operation. For instance, if the engine is electronically controlled, sensors may feed an on-board computer data relating to the load placed on the engine, gearing, temperature, humidity, octane or other fuel variables, oxygen levels, altitude, etc. All of these variables can be processed and factored in so that the timing and amount of fuel delivery as well as timing of fuel ignition can be tuned accordingly with great variation and efficiency since the space inside the combustion chamber is quite large compared to a reciprocating engine and the ignition of the fuel and air mixture can occur over a much broader range of time and location of piston travel.

All of the embodiments of the invention can be utilized in a “ganged” up or combination arrangement, with multiple engine assemblies stacked up one on or adjacent the other to be provide increased power to the extent necessary in any given application.

Further, all of the embodiments may comprise multiple combustion chambers and either retracting pistons or gates inside of the chambers. They do not have to be single piston and gate assemblies as described above. The description and illustrations are configured for the purpose of simplicity in describing the attributes of the invention. Additionally, if there is more than one combustion chamber in any embodiment, there may be no need for all or any of the combustion chambers to be identical in size or equal in spacing. In fact, there may be applications where it may be beneficial for the chambers to be unequal in size so that the timing of ignition or other variables may be offset. In this regard, reference is made to the pump design described herein. This offset may facilitate a smoother and more continuous application of power. In the pump design of this invention, it will allow for a continuous flow of whatever gas or liquid or other material is being pumped.

Additionally, all of the embodiments of the invention may be designed with a larger combustion chamber rather than keeping the combustion chamber the same dimension as the tightly fitting “cylinder” space. This would allow for the use of the “venturi” effect as in a rocket engine whereby the larger spaced combustion chamber would then narrow down to a smaller space thereby increasing the force and pressure on the piston, as well as allowing for a greater volume of fuel and air to be ignited for greater force as well. This embodiment is also described and illustrated elsewhere herein.

It is to be noted that all of the embodiments may be scalable so that they can be produced both on a microscopic level, potentially even on a nano-scale, or enlarged to gigantic proportions comparable to the largest reciprocating engines of today that drive great ships etc.

Because of the relative simplicity of the design, it is also an advantage of the present invention that the engines incorporating the rotary piston arrangement will have considerable durability and longevity. The simplicity of design may also result in engines which will require fewer moving parts, and less material to construct therefor, with the consequence that they will be easier and less costly to manufacture and maintain. The nature of the invention may furthermore cause the engines to be lighter per pound in relation to work output than is the case with engines which use conventional reciprocating pistons in combustion chambers.

The increased simplicity of the design may also have the benefit of a more compact size than reciprocating engines of the same power output. And there may also be fewer toxic emissions as a result thereof.

One advantageous aspect of engines constructed in accordance with the invention is that the continuous movement of the piston in its chamber may cause these engines to operate more quietly than counterpart reciprocating engines. The continuous movement of the piston in its chamber may also cause these engines to operate more smoothly and with less vibration as compared with corresponding reciprocating engines. And the reduced friction inherent in the operation of engines of the invention may lead to the operation thereof at a lower temperature.

In the various embodiments of the invention, the distance between the piston and the crankshaft can also be varied depending upon the usage and application of the engine. As the distance from the crankshaft to the piston increases, there may be an increase in leverage, but a decrease in speed, another facet of variability that can be used to advantage in order to give this engine of the invention the increased benefit depending upon usage.

In one aspect, superchargers and/or turbochargers may also be employed to enhance or improve power output by forcing air into the intake valves giving the engines greater power and or efficiency.

Gangs or stacks or banks of a plurality of engines may be provided to team up to drive either fans or propellers for watercraft and aircraft use. The same may apply with respect to providing water jet power for watercraft use.

In one aspect of the invention, the piston may be hollow so that upon starting the engine the piston will have a lower weight, to facilitate faster spool up to speed. As the engine reaches desired or selected speeds, heavy liquid or other material can be pumped into at least some or all of the pistons so that inertial forces can be harnessed to maximum effect.

While the current preferred common shape for the internal combustion engine cylinder is a tube, alternative embodiments of the present invention do not have to adhere to this specific format, and it is within the scope of the present invention to provide other shapes which may, for example, be easy to manufacture and that also maximize or enhance the efficiency of the engine.

It is within the scope of the invention that each rotary engine can also be made into a pump design, in order to pump liquids such as water, or air and gases. One of the benefits of this design for a pump is the ease with which the design can be adapted to provide continuous flow of the material being pumped. This can be contrasted with the motion of a conventional design which utilizes reciprocating pistons or pumps which by necessity almost always require an intermittent flow of gas or liquid, when flow may be interrupted or reduced during the return stroke of the piston.

The engines in accordance with the invention can also be run by external combustion or steam power, much the way that turbines are currently operated in power plants, with steam or other hot gases piped into the intake valves.

Furthermore, the engines can also be run by water or other liquid pressure by piping, in a similar manner, water or liquid into the intake valves.

Also, there may be two traveling walls for instance in FIGS. 19 and 20. In these cases the piston may be mounted on a plate and this may necessitate two traveling walls on either side of the chamber to seal the chamber.

1. A rotary engine comprising:
a substantially circular hollow chamber including an outer wall portion and an inner wall portion;
a piston which moves through the chamber in response to combustion of a fuel and air mixture in the chamber, the piston being connected to a piston rod which drives a shaft outside the chamber;
a gate formed in the chamber providing a transverse seal therein, the gate and piston being configured so that the piston or gate are movable relative to each other between a first position in which the chamber is sealed by the gate and a second position in which the piston avoids the gate as it moves through the chamber; and
the inner wall of the chamber comprising a fixed wall portion which does not move relative to the piston and a traveling wall portion which moves with the piston, the fixed wall portion and traveling wall portion of the inner wall forming a substantial seal therebetween.

2. A rotary engine as claimed in claim 1 wherein the gate is movable between a closed position in which it seals the chamber and an open position wherein the chamber is unsealed and the piston can move freely past the gate, the gate moving to the open position when the piston is close to moving toward the gate in the chamber and to the closed position when the piston is moving away from the gate.

3. A rotary engine as claimed in claim 1 wherein the gate is fixed in the chamber and the position of the piston changes as it approaches the gate to move in a path such that the gate does not obstruct the piston.

4. A rotary engine as claimed in claim 1 wherein the piston moves out of the chamber and around the gate.

5. A rotary engine as claimed in claim 3 wherein the gate comprises a door therein and the piston is reoriented as it approaches the gate, the door in the gate opening to permit the piston to move through the gate.

6. A rotary engine as claimed in claim 3 wherein the piston is hingedly connected at one end thereof such that the piston moves about the hinge out of the way of the gate in its circular motion in the chamber.

7. A rotary engine as claimed in claim 1 wherein the fixed wall portion is between the moving piston and the traveling wall portion and the fixed wall portion has a slot therein for receiving the piston rod, the piston rod being connected to the traveling wall portion and passing through the slot of the fixed wall portion to connect to the piston, the slot in the fixed wall portion being sealed by the presence of the traveling wall portion to prevent combustion gases from escaping from the chamber through the slot.

8. A rotary engine as claimed in claim 2 wherein the gate moves radially outwardly to the open position.

9. A rotary engine as claimed in claim 2 wherein the gate moves radially inwardly to the open position.

10. A rotary engine as claimed in claim 1 further comprising a counterweight connected to the crankshaft.

11. A rotary engine as claimed in claim 1 wherein the chamber comprises as ring-shaped tubular member in which the piston follows a continuous circular pathway.

12. A rotary engine as claimed in claim 1 further comprising a rotating cam member which is configured to open the gate as the piston approaches the gate.

13. A rotary engine as claimed in claim 12 further comprising a first roller slot and a second roller slot, the first and second roller slots receiving a roller, the cam member moving the roller between the first and second roller slots so that the gate is closed when the roller is in the first roller slot and open when the roller is in the second roller slot.

14. A rotary engine as claimed in claim 1 wherein the piston rod comprises a hollowed out portion and the piston retracts into the hollowed out portion of the piston rod when the piston passes the gate when fixed in the chamber.

15. A rotary engine as claimed in claim 1 wherein:
the piston comprises an elongate member having side ends and a substantially elongate axis and pivotally mounted in the chamber, the piston being movable between a first position wherein the elongate axis of the elongate member is substantially transverse to the direction of movement and seals the side ends against the walls of the chamber, and a second position wherein the elongate axis of the elongate member is moved through approximately 90 degrees so that the elongate axis is substantially parallel to the direction of movement; and
the gate has a door therein which is of sufficient size to permit the elongate member to pass through when in the second position and the door is opened at the approach thereto of the elongate member and closed when the elongate member has passed therethrough.

16. A rotary engine as claimed in claim 1 wherein the hollow chamber comprises a wider combustion chamber portion adjacent the gate and in which combustion occurs and a narrower travel chamber portion downstream of the wider combustion chamber portion, wherein combustion occurs at the point where the piston enters the narrower travel chamber portion.

17. A rotary engine as claimed in claim 1 comprising at least two pistons each associated with a piston rod which travel through the chamber, the two pistons being spaced from each other and relatively movable with respect to the gate to allow each piston to pass the gate unobstructed.

18. A rotary engine comprising:
a substantially circular hollow chamber including an upper fixed plate and a lower moving plate which cooperate to form the chamber;
a piston connected to the moving plate and which moves through the circular chamber in response to combustion of a fuel and air mixture in the chamber, the moving plate driving a crankshaft; and
a gate formed in the chamber for providing a transverse seal therein, the gate and piston being configured so that the gate is movable relative to the piston between a first position in which the chamber is sealed by the gate and a second position in which the gate is moved at least partially out of the chamber so that the piston avoids the gate as it moves through the chamber.

19. A rotary engine as claimed in claim 18 further comprising a first roller slot and a second roller slot on or in the moving plate, the first and second roller slots receiving a roller, and a cam member moving the roller between the first and second roller slots so that the gate is closed when the roller is in the first roller slot and open when the roller is in the second roller slot.

20. A rotary engine as claimed in claim 1 further comprising: drive mechanisms for opening and closing the gate; sensors for sensing the position of the gate and piston; and a processor for operating the drive mechanisms to selectively open and close the gate in response to the sensed position of the piston.

21. A rotary engine as claimed in claim 20 wherein the processor can selectively determine and vary the timing of combustion in relation to the position of the gate and/or piston to allow for the combustion chamber to be effectively variable in volume and that the volume variance is utilized to better respond to changing loads and conditions; and optimize performance.

22. A method of operating a rotary engine comprising the following steps:
forming a substantially circular hollow chamber including an outer wall portion and an inner wall portion;
moving a piston through the chamber in response to combustion of a fuel and air mixture in the chamber, the piston being connected to a piston rod which drives a shaft outside the chamber;
locating a gate in the chamber to provide a transverse seal therein, the gate and piston being operated so that the piston or gate are movable relative to each other between a first position in which the chamber is sealed by the gate and a second position in which the piston avoids the gate as it moves through the chamber; and
forming the inner wall of the chamber of a fixed wall portion which does not move relative to the piston and a traveling wall portion which moves with the piston, the fixed wall portion and traveling wall portion of the inner wall forming a substantial seal therebetween.

23. A method as claimed in claim 23 wherein the gate is moved out of the chamber at the approach of the piston.

24. A method as claimed in claim 22 wherein the gate and piston can be held in unobstructive positions for an extended length of time in order to allow the engine to free spool with the residual energy of previous combustion cycles.

25. A rotary engine as claimed in claim 1 wherein the piston or gate may move in the up and down direction.

26. A rotary engine as claimed in claim 1 wherein the piston is hollow to be of lower weight upon start up and a means is provided to fill the piston with material or liquid once it is spinning in order to increase and store more inertial energy in the moving piston.

27. A rotary engine as claimed in claim 1 wherein:
the piston comprises an elongate member having lateral portions each pivotally mounted in the chamber, the piston being movable between a first position wherein the lateral portions are substantially transverse to the direction of movement and seal against the walls of the chamber, and a second position wherein each lateral portion is moved through approximately 90 degrees so that they are substantially parallel to the direction of movement; and
the gate has doors therein which are of sufficient size to permit the lateral portion to pass through when in the second position and the door is opened at the approach thereto of the lateral portions and closed when the lateral portions have passed therethrough.
